(19) United States
(12) Patent Application Publication
(10) Pub. No.: US 2026/0002788 A1
(43) Pub. Date: Jan. 1, 2026

(54) RULEBOOK-COMPLIANT SPATIO-TEMPORAL SAFETY CORRIDORS

(71) Applicant: Torc Robotics, Inc., Blacksburg, VA (US)

(72) Inventors: Zachary Alan Brock, Salt Lake City, UT (US); Rikki Valverde, Bala Cynwyd, PA (US); Ira Hill, Christiansburg, VA (US)

(21) Appl. No.: 18/759,142

(22) Filed: Jun. 28, 2024

(51) Int. Cl. G01C 21/34; B60W 50/00; B60W 60/00

(52) U.S. Cl. CPC G01C 21/3492; B60W 50/0098; B60W 2520/10; B60W 2720/10; B60W 2720/24; B60W 60/001

(57) ABSTRACT

A motion planning system includes a memory configured to store constraints having different priorities, and at least one processor. The processor(s) are configured to identify a reference path through a spatiotemporal space that includes at least two spatial dimensions and a time dimension, where the at least two spatial dimensions define a spatial frame, and where the reference path is defined as a sequence of states of the vehicle along the reference path. The processor(s) are further configured to identify, at each of the sequence of states, a priority of a constraint that is being violated, generate, at each of the sequence of states, a bounding box having an area in the spatial frame that does not violate remaining constraints having higher priorities, and generate, based on the bounding box at each of the sequence of states, a spatiotemporal safety corridor for the vehicle through the spatiotemporal space.

### TECHNICAL FIELD

The field of the disclosure relates generally to autonomous and semi-autonomous vehicles, and more particularly, to motion planning for autonomous and semi-autonomous vehicles.

### BACKGROUND

Motion planning for autonomous and semi-autonomous vehicles may include defining an initial coarse route through a drivable space around the vehicle, and subsequently, defining a smoother route based on the coarse route that improves driving outcomes. However, generating the smoother route may be problematic when the smoother route violates rules or constraints that were previously met by the coarse route.

There is consequently a need to ensure that planning and execution of generating the smoother route is flexible enough to improve driving outcomes while maintaining adherence to at least some of the rules initially met when the initial coarse route was generated.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one embodiment, a motion planning system for planning motion for a vehicle is provided. The motion planning system includes a memory configured to store a plurality of constraints having different priorities, and at least one processor. The at least one processor is configured to identify a reference path through a spatiotemporal space that includes at least two spatial dimensions and a time dimension, where the at least two spatial dimensions define a spatial frame, and where the reference path is defined as a sequence of states of the vehicle along the reference path. The at least one processor is further configured to identify, at each of the sequence of states along the reference path, a priority of a constraint of the plurality of constraints that is being violated by the reference path, and generate, at each of the sequence of states along the reference path, a bounding box around the reference path having an area in the spatial frame that does not violate remaining constraints of the plurality of constraints having priorities higher than the priority of the constraint that is being violated by the reference path. The at least one processor is further configured to generate, based on the bounding box at each of the sequence of states along the reference path, a spatiotemporal safety corridor for the vehicle through the spatiotemporal space.

In another embodiment, a method of planning motion for a vehicle is provided. The method includes identifying a reference path through a spatiotemporal space that includes at least two spatial dimensions and a time dimension, where the at least two spatial dimensions define a spatial frame, and where the reference path is defined as a sequence of states of the vehicle along the reference path. The method further includes identifying, at each of the sequence of states along the reference path, a priority of a constraint of the plurality of constraints that is being violated by the reference path, and generating, at each of the sequence of states along the reference path, a bounding box around the reference path having an area in the spatial frame that does not violate remaining constraints of the plurality of constraints having priorities higher than the priority of the constraint that is being violated by the reference path. The method further includes generating, based on the bounding box at each of the sequence of states along the reference path, a spatiotemporal safety corridor for the vehicle through the spatiotemporal space.

In another embodiment, a motion planning system for planning motion for a vehicle is provided. The motion planning system includes a memory and at least one processor. The memory configured to store a first constraint having a first priority and a second constraint having a second priority, where the first priority is higher than the second priority, and where the first constraint and the second constraint represent at least one of (i) obstacles in a spatial frame and safety regions around the obstacles, and (ii) rules of the road. The at least one processor is configured to identify a reference path through a spatiotemporal space that includes at least two spatial dimensions and a time dimension, where the at least two spatial dimensions define a spatial frame, and where the reference path is defined as a sequence of states of the vehicle along the reference path. The at least one processor is further configured to determine, at one of the sequence of states along the reference path, that the second constraint having the second priority is being violated by the reference path, and generate, at the one of the sequence of states along the reference path, a bounding box around the reference path having an area in the spatial frame that does not violate the first constraint having the first priority. The at least one processor is further configured to generate, based on the bounding box at the one of the sequence of states along the reference path, a spatiotemporal safety corridor for the vehicle through the spatiotemporal space.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts a vehicle that includes a motion planning system in an exemplary embodiment.

FIG. 2 depicts a block diagram of the motion planning system of FIG. 1 in an exemplary embodiment.

FIG. 3 depicts a spatiotemporal space that includes a reference path for the vehicle of FIG. 1in an exemplary embodiment.

FIG. 4 depicts bounding box inflation in an exemplary embodiment.

FIG. 5 depicts a reference path for the vehicle of FIG. 1 that includes a plurality of bound boxes in an exemplary embodiment.

FIG. 6 depicts a spatiotemporal safety corridor in an exemplary embodiment.

FIG. 7 depicts the spatiotemporal safety corridor of FIG. 6 from a longitudinal-time (S-T) plane in an exemplary embodiment.

FIG. 8 depicts the spatiotemporal safety corridor of FIG. 6 from a lateral-time (L-T or D-T) plane in an exemplary embodiment.

FIG. 9 depicts another spatiotemporal safety corridor in an exemplary embodiment.

FIG. 10 depicts the spatiotemporal safety corridor of FIG. 9 from a longitudinal-time (S-T) plane in an exemplary embodiment.

FIG. 11 depicts the spatiotemporal safety corridor of FIG. 9 from a lateral-time (L-T or D-T) plane in an exemplary embodiment.

FIG. 12 depicts a block diagram of an autonomous driving system in an exemplary embodiment.

FIG. 13 depicts a flow chart of a method of planning motion for a vehicle in an exemplary embodiment.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

Motion planning for autonomous and semi-autonomous vehicles may include defining an initial route through a drivable space around the vehicle based on rules. The rules, for example, may define operating distances from other vehicles, obstacles, and the like. In some cases, a system has leeway to allow for a deviation around the initial route in order to provide a more smooth and continuous driving outcome. However, determining the deviations from the initial route may be challenging, as such deviations may violate rules or constraints that were previously met by the initial route.

For example, a system may generate a coarse route through a drivable space, which is then refined to be smooth and continuous for better driving outcomes. The system may, for example, be designed to observe a hierarchy of constraints, referred to as a rulebook, such that the system knows what higher priority constraints should be observed while also determining which constraints may be violated in order to observe a higher priority constraint. In order for the system to have the flexibility to generate a smooth route, the system should be allowed to turn the coarse route into a set of bounded areas around the coarse route that the system could search within for a smooth route while ensuring that the smooth route would not violate higher priority constraints that the coarse route did not.

The pending application describes systems and a method for planning motion for an autonomous or semi-autonomous vehicle. In one embodiment, a motion planning system is described that receives a reference path through a spatiotemporal space, identifies, at each of a sequence of states along the reference path, a priority of a constraint that is being violated by the reference path, and generates, at each of the sequence of states along the reference path, a bounding box around the reference path that has an area that does not violate remaining constraints having priorities higher than what was initially violated by the reference path. This ensures that the initial higher priority constraints that were not violated by the reference path are not subsequently violated when generating a route that deviates from the reference path.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

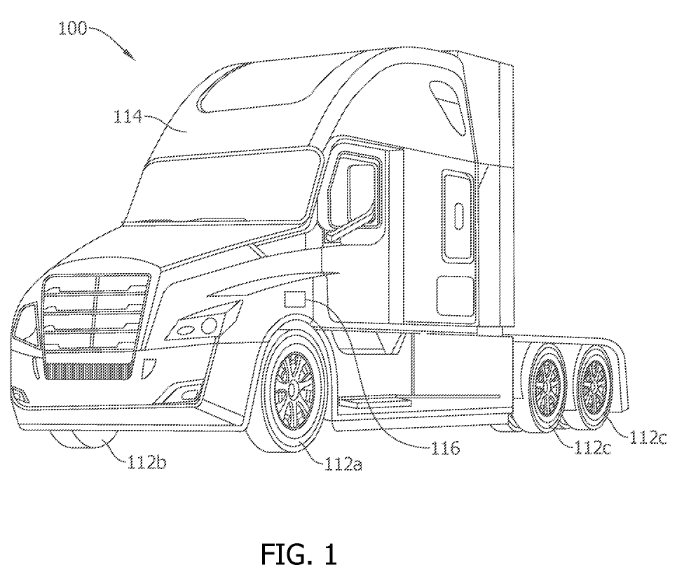

FIG. 1 depicts a vehicle 100 in an exemplary embodiment. Vehicle 100 may include an autonomous or semi-autonomous vehicle such as a truck. The truck may further be conventionally connected to a single or tandem trailer to transport the trailer(s) (not shown) to a desired location. Vehicle 100 includes a cab 114 that can be supported by, and steered in, the required direction by front wheels 112a, 112b, and rear wheels 112c that are partially shown in FIG. 1. Front wheels 112a, 112b are positioned by a steering system that includes a steering wheel and a steering column (not shown in FIG. 1). The steering wheel and the steering column may be located in the interior of cab 114. The steering wheel and the steering column, as well as the entire cabin may be omitted in an autonomous vehicle. In this embodiment, vehicle 100 further includes a motion planning system 116. Motion planning system 116 operates to plan a motion of vehicle 100 through a drivable space around vehicle 100.

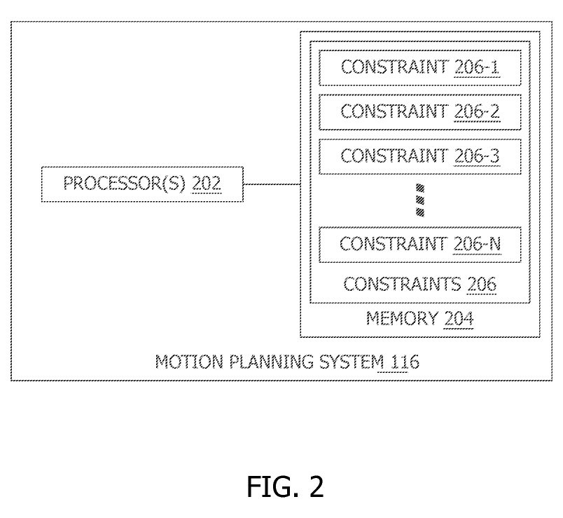

FIG. 2 depicts a block diagram of the motion planning system 116 of FIG. 1 in an exemplary embodiment. Motion planning system 116 comprises any component, system, or device that performs the functionality described herein for motion planning system 116. Motion planning system 116 will be discussed with respect to various discrete elements, which perform functions. These elements may be combined in different embodiments, segmented into different discrete elements in other embodiments, or removed in some embodiments.

In this embodiment, motion planning system 116 includes at least one processor 202 communicatively coupled with at least one memory 204. In some embodiments, processor 202 executes programmed instructions (e.g., which may be stored by memory 204) in order to perform the functionality described herein for motion planning system 116. In other embodiments, processor 202 and/or memory 204 comprise logic that implements the functionality described herein for motion planning system 116.

In this embodiment, memory 204 stores a plurality of constraints 206 for motion planning system 116. In particular, memory 204 stores constraints 206-1, 206-2, 206-3, 206-N, where N is an arbitrary number of constraints 206. Although four of constraints 206 are illustrated in FIG. 2, memory 204 may store any number of constraints 206 greater than or equal to two.

In this embodiment, constraints 206 are organized in a hierarchy of priority, such that constraint 206-1 has a higher priority than constraint 206-2, constraint 206-2 has a higher priority than constraint 206-3, and constraint 206-3 has a higher priority than constraint 206-N, etc.

Constraints 206 generally define the rules for planning a route for vehicle 100. Some examples of constraints 206 include obstacles and the safety regions around the obstacles, rules of the road, the capability of vehicle 100 to vary its velocity and/or direction, etc. Constraints 206 related to obstacles may define, for example, a priority associated with maintaining a pre-defined distance or a range of distances from a guardrail at the side of a road, a priority associated with maintaining a pre-defined distance or a range of distances from a pedestrian, a priority associated with maintaining a pre-defined distance or a range of distances from another vehicle, etc. In some embodiments, the safety regions vary based on a predicted velocity of vehicle 100 at different points along the route.

Constraints 206 related to the rules of the road may define, for example, priorities associated with adhering to the current rules of the road, including speeds, which lanes of the road to utilize, when to pass other vehicles, etc. Constraints 206 related to the ability of vehicle 100 to vary its velocity or direction may define, for example, limits to deceleration, acceleration, turning rates, etc.

During operation of motion planning system 116, processor 202 identifies a reference path through a spatiotemporal space. The spatiotemporal space includes at least two spatial dimensions and a time dimension, and the at least two spatial dimensions define a spatial frame. For example, a reference path for vehicle 100 may include longitudinal motion and lateral motion of vehicle 100 on a road over time. The reference path may be generated by processor 202 and/or received by another system, such as the tactical planner previously described, with the reference path representing a coarse route or initial route through the spatiotemporal space.

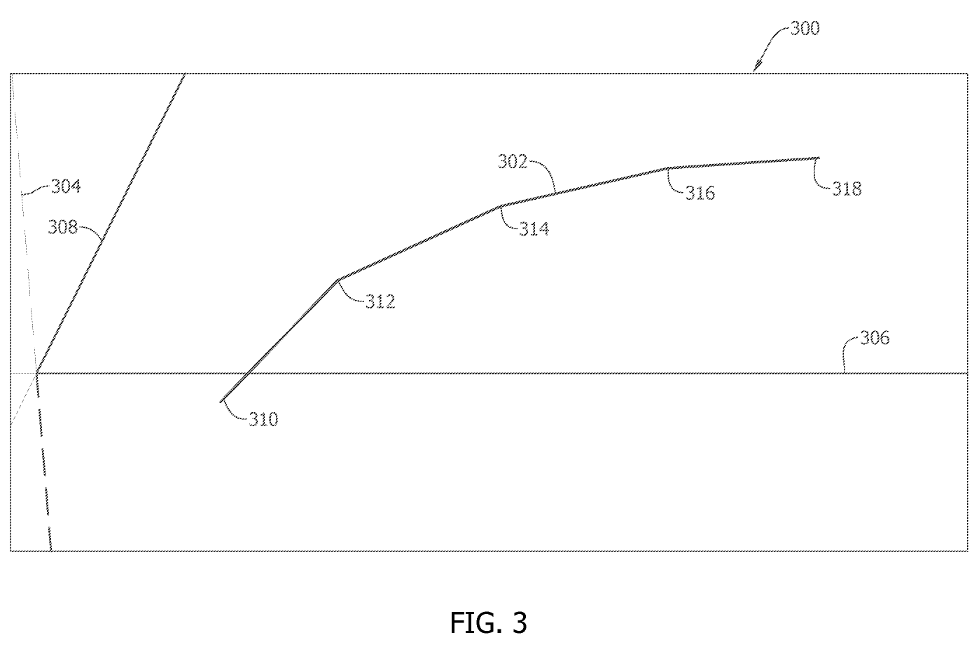

FIG. 3 depicts a spatiotemporal space 300 that includes a reference path 302 for vehicle 100 in an exemplary embodiment. In one embodiment, reference path 302 is generated by an external system and provided to motion planning system 116. In another embodiment, reference path 302 is generated by motion planning system 116. Reference path 302 may comprise a coarse route through spatiotemporal space 300, which may be refined by motion planning system 116 to provide a smoother route through spatiotemporal space 300.

In this embodiment, spatiotemporal space 300 includes a lateral dimension 304, a longitudinal dimension 306, and a time dimension 308. Collectively lateral dimension 304 and longitudinal dimension 306 define a spatial frame for spatiotemporal space 300. In this embodiment, reference path 302 includes a sequence of states 310, 312, 314, 316, 318 of vehicle 100. Although reference path 302 is depicted as including five states 310, 312, 314, 316, 318, reference path 302 may include a different number of states 310, 312, 314, 316, 318 in other embodiments.

States 310, 312, 314, 316, 318 may be generated, for example, as a sequence of ego states for vehicle 100, with the ego states defining various characteristics of vehicle 100 at different points along reference path 302 such as acceleration, deceleration, lateral movement, longitudinal movement, distances to obstacles, speeds, etc.

In this embodiment, reference path 302 violates at least one of constraints 206, and processor 202 identifies, at each of the sequence of states 310, 312, 314, 316, 318 along reference path 302, a priority of constraint 206 that is being violated by reference path 302. For example, reference path 302 may violate constraint 206-2 at state 312 of vehicle 100, and violate constraint 206-3 at state 314 of vehicle 100, and processor 202 identifies the priority of constraint 206-2 at state 312, and the priority of constraint 206-3 at state 314.

Processor 202 generates, at each of the sequence of states 310, 312, 314, 316, 318 along reference path 302, a bounding box around reference path 302 having an area in the spatial frame that does not violate remaining constraints 206 having priorities higher than the constraints 206 violated by reference path 302.

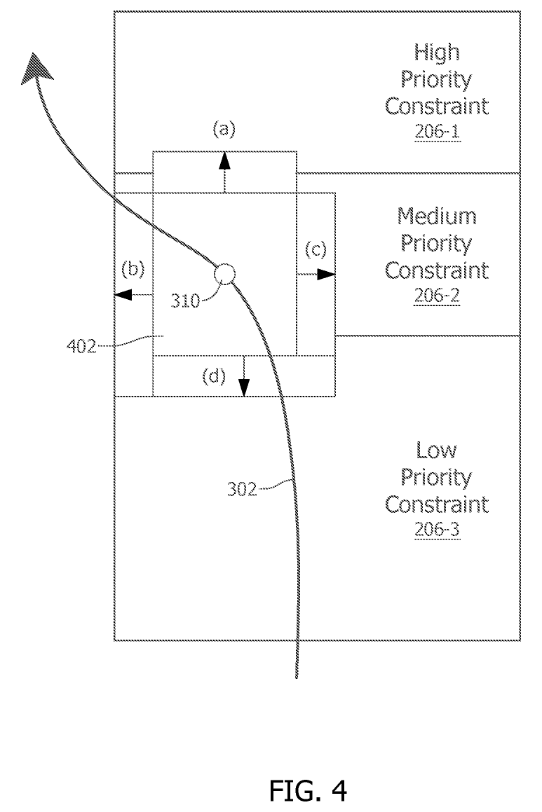

FIG. 4 depicts bounding box inflation in an exemplary embodiment. FIG. 4 depicts an example of bounding box inflation at state 310 of reference path 302, but the general process applies to other states 312, 314, 316, 318. In FIG. 4, an initial bounding box 402 is generated around state 310. During inflation, expansion in each of directions a, b, c, d, is attempted. Expansion in direction a is blocked because it would violate constraint 206-1, which has a higher priority than constraint 206-2. Expansion in directions b, c, d are allowed because the resulting regions only violate constraints of the same or lower priority as is currently being violated by state 310 (e.g., constraint 206-2).

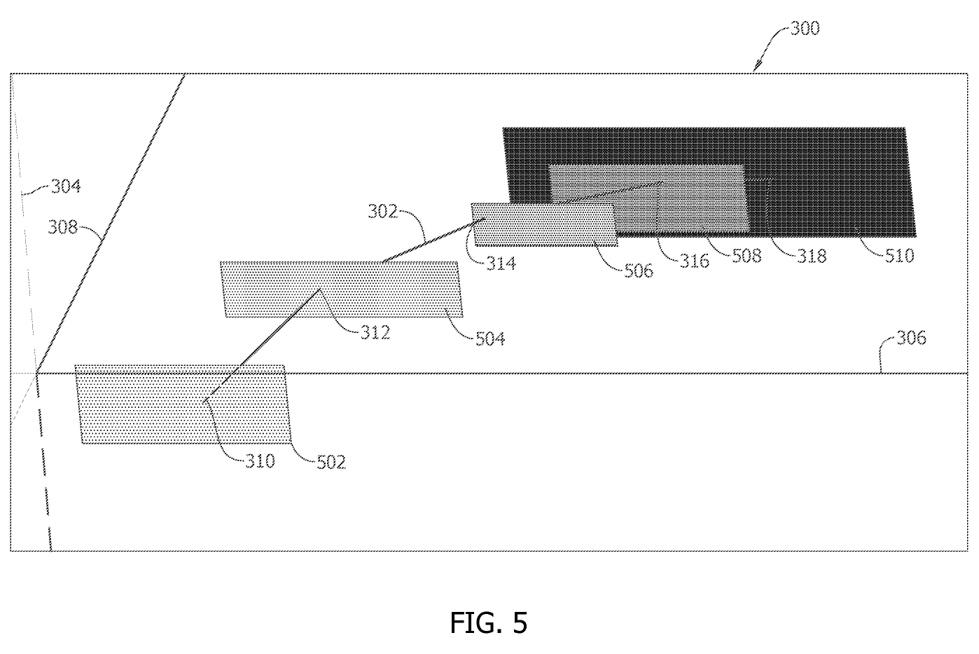

FIG. 5 depicts reference path 302 for vehicle 100 that includes a plurality of bounding boxes 502, 504, 506, 508, 510 in an exemplary embodiment. In FIG. 5, bounding boxes 502, 504, 506, 508, 510 are generated by processor 202 at states 310, 312, 314, 316, 318, respectively, along reference path 302.

In continuing with the example above, processor 202 generates bounding box 504 at state 312 of vehicle 100 that does not violate constraint 206-1 (as constraint 206-2 is already being violated by reference path 302 at state 312 and constraint 206-1 has a higher priority than constraint 206-2). Processor 202 generates bounding box 506 at state 314 of vehicle 100 that does not violate constraint 206-2 (as constraint 206-3 is already being violated by the reference path at state 314, and constraint 206-2 has a higher priority than constraint 206-3).

In response to generating the bounding boxes 502, 504, 506, 508, 510, processor 202 generates, based on bounding box 502, 504, 506, 508, 510 at each of states 310, 312, 314, 316, 318, respectively, a spatiotemporal safety corridor for vehicle 100 through spatiotemporal space 300.

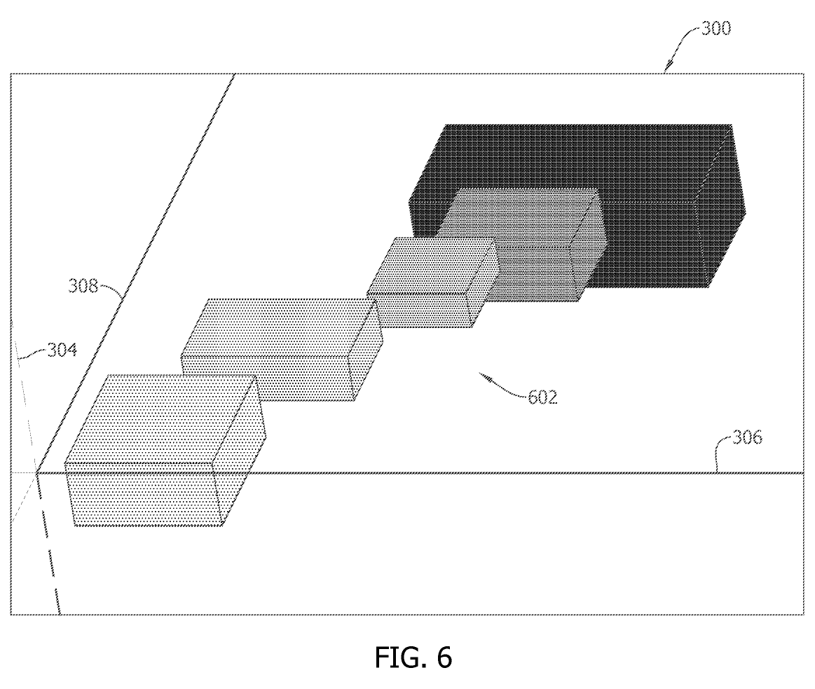

FIG. 6 depicts a spatiotemporal safety corridor 602 in an exemplary embodiment. In FIG. 6, spatiotemporal safety corridor 602 is a rectangular projection (extrusion) generated based on bounding boxes 502, 504, 506, 508, 510 (see FIG. 5).

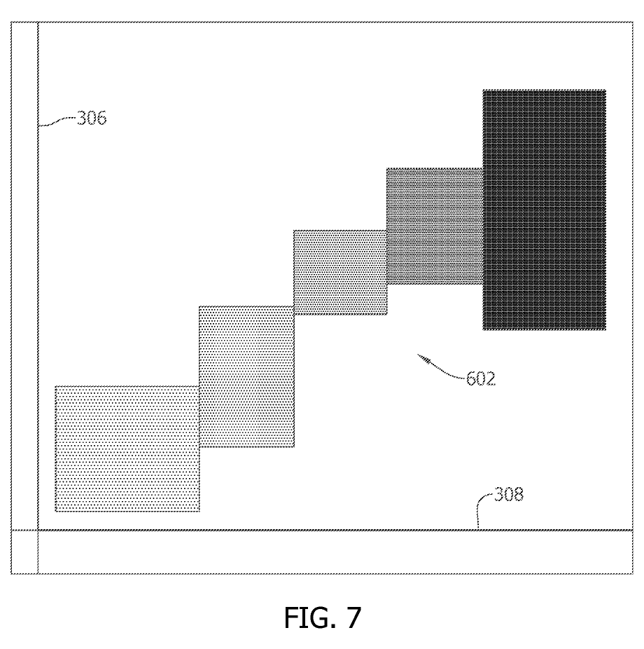

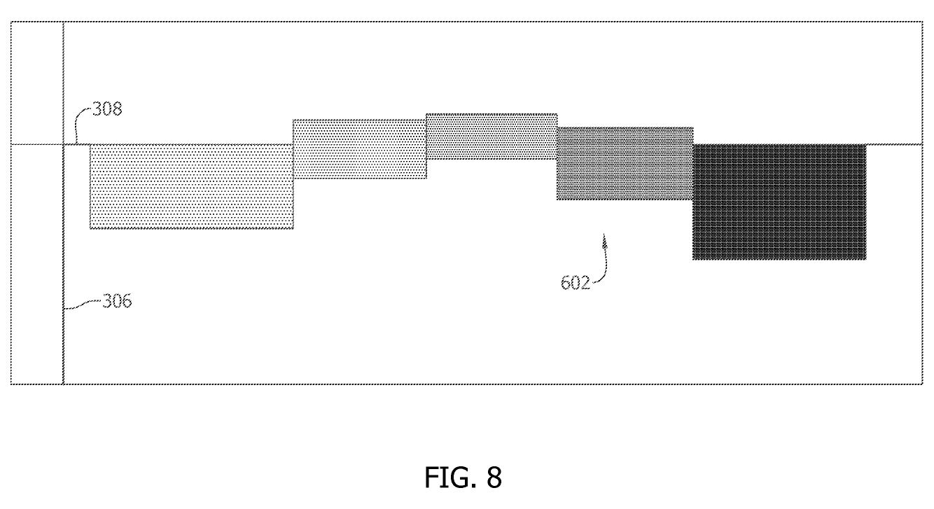

FIG. 7 depicts spatiotemporal safety corridor 602 from the longitudinal-time (S-T) plane in an exemplary embodiment, and FIG. 8 depicts spatiotemporal safety corridor 602 from the lateral-time (L-T or D-T) plane in an exemplary embodiment.

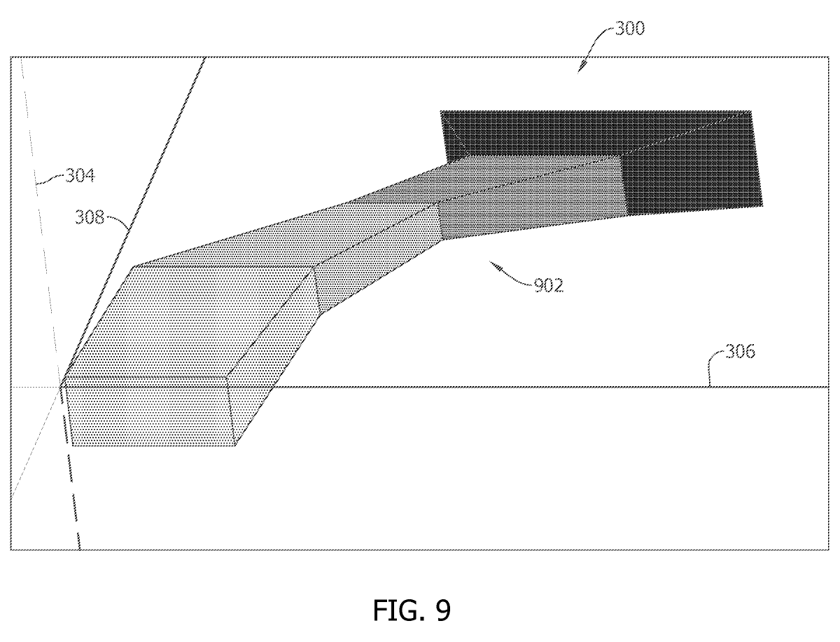

FIG. 9 depicts another spatiotemporal safety corridor 902 in an exemplary embodiment. In FIG. 9, spatiotemporal safety corridor 902 is a trapezoidal projection generated based on bounding boxes 502, 504, 506, 508, 510 (see FIG. 5).

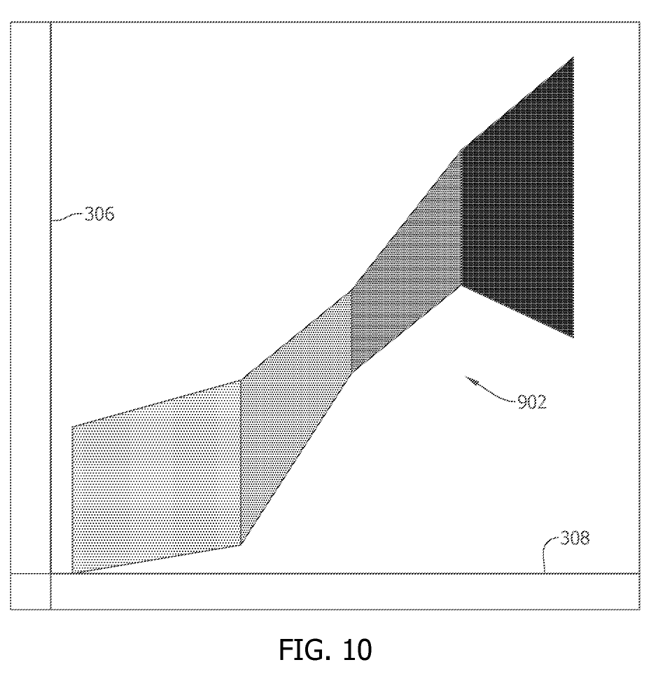

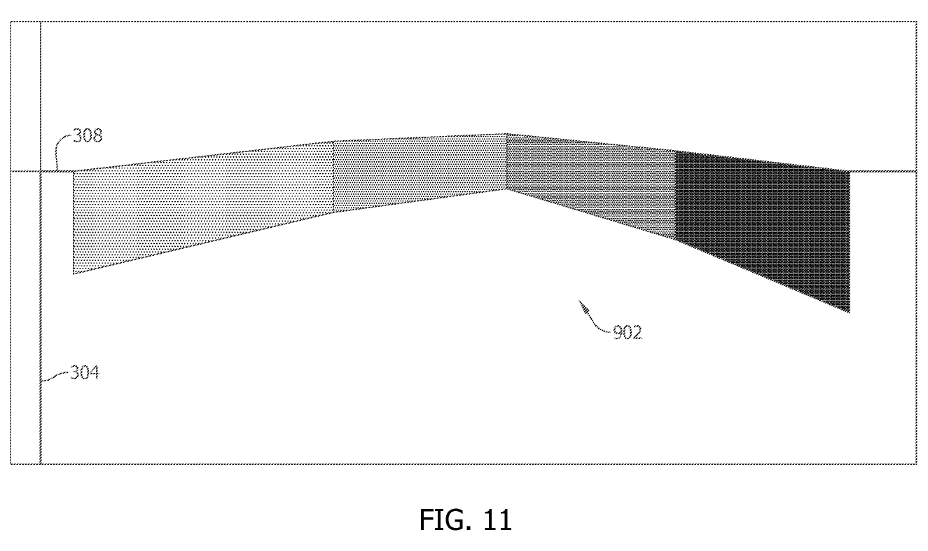

FIG. 10 depicts spatiotemporal safety corridor 902 from the longitudinal-time (S-T) plane in an exemplary embodiment, and FIG. 11 depicts spatiotemporal safety corridor 902 from the lateral-time (L-T or D-T) plane in an exemplary embodiment. Although spatiotemporal safety corridors 602, 902 have been depicted as having a particular shape, processor 202 may generate spatiotemporal safety corridors based on bounding boxes 502, 504, 506, 508, 510 to have different shapes in other embodiments.

In these embodiments, spatiotemporal safety corridors 602, 902 vary along reference path 302 based on bounding boxes 502, 504, 506, 508, 510, and spatiotemporal safety corridors 602, 902 define an area around reference path 302 that motion planning system 116 may utilize to plan a route for vehicle 100 in order to generate a more smooth and continuous driving outcome for vehicle 100. Spatiotemporal safety corridors 602, 902 therefore define limits on how motion planning system 116 may implement a smooth route for vehicle 100 while ensuring that the smooth route will not violate constraints 206 having higher priorities than constraints 206 that were initially violated by reference path 302.

In some embodiments, processor 202 identifies, at each of states 310, 312, 314, 316, 318 along reference path 302, a highest priority constraint 206 that is being violated. For example, processor 202 identifies constraint 206-2 as having the highest priority constraint 206 being violated, even though other constraints having a lower priority may also be violated at state 312 (e.g., both of constraints 206-2, 206-3 may be violated at state 312).

In some embodiments, to generate bounding boxes 502, 504, 506, 508, 510 at each of states 310, 312, 314, 316, 318, processor 202 generates bounding boxes 502, 504, 506, 508, 510 to have an area that is not greater than (i) the area in the spatial frame that does not violate the remaining constraints 206 having priorities higher than constraints 206 being violated, or (ii) a pre-determined maximum area. For example, the area of bounding box 504 at state 312 may be no greater than the area in the spatial frame that does not violate constraint 206-1 (as constraint 206-2 is already being violated by reference path 302 at state 312 and constraint 206-1 has a higher priority than constraint 206-2) or the pre-defined maximum area.

In some embodiments, the pre-defined maximum area is based on a multiple of a width of a lane of a road. In other embodiments, the pre-defined maximum area is based on a multiple of the length of vehicle 100.

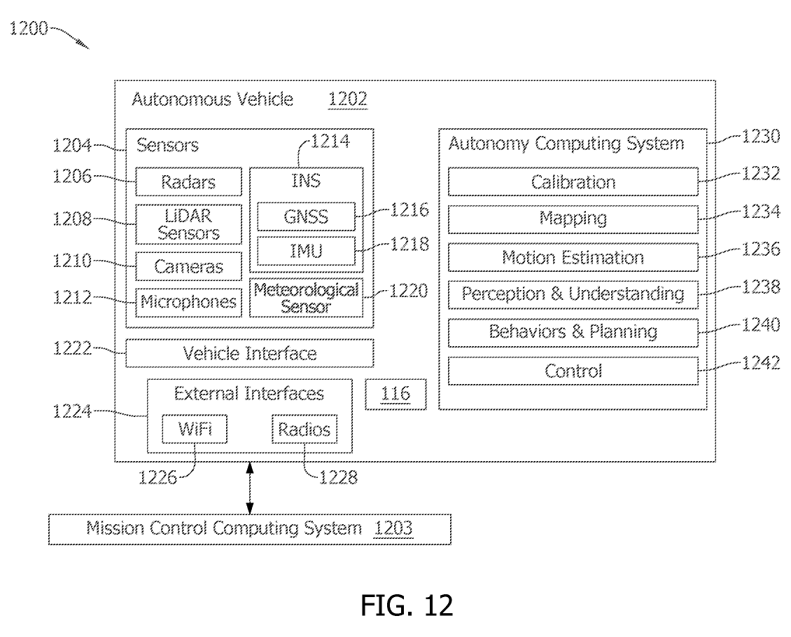

FIG. 12 depicts a block diagram of an autonomous driving system 1200 in an exemplary embodiment. Autonomous driving system 1200 includes an autonomous vehicle 1202 that is communicatively coupled with a mission control computing system 1203. Autonomous vehicle 1202 may be similar or the same as described with respect to vehicle 100 and motion planning system 116.

In this embodiment, autonomous vehicle 1202 includes sensors 1204. Sensors 1204 may include radio detection and ranging (RADAR) sensors 1206, light detection and ranging (LiDAR) sensors 1208, cameras 1210, and microphones 1212. Sensors 1204 may further include an inertial navigation system (INS) 1214 configured to determine states such as the location, orientation, and velocity of autonomous vehicle 1202. INS 1214 may include at least one global navigation satellite system (GNSS) receiver 1216 configured to provide positioning, navigation, and timing using satellites. INS 1214 may also include at least one inertial measurement unit (IMU) 1218 configured to measure motion properties such as the angular velocity, linear acceleration, or orientation (e.g., tipping) of autonomous vehicle 1202. Sensors 1204 may further include meteorological sensors 1220. Meteorological sensors 1220 may include a temperature sensor, a humidity sensor, an anemometer, pitot tubes, a barometer, a precipitation sensor, or a combination thereof. Meteorological sensors 1220 are used to acquire meteorological data, such as the humidity, atmospheric pressure, wind, or precipitation, of the ambient environment of autonomous vehicle 1202.

Autonomous vehicle 1202 may further include a vehicle interface 1222, which interfaces with an engine control unit (not shown) or an automotive control unit (not shown) of autonomous vehicle 1202 to control the operation of autonomous vehicle 1202 such as acceleration, braking and steering.

Autonomous vehicle 1202 may further include external interfaces 1224 configured to communicate with external devices or systems such as another vehicle or mission control computing system 1203. External interfaces 1224 may include Wi-Fi 1226, other radios 1228 such as Bluetooth, or other suitable wired or wireless transceivers such as cellular communication devices. Data detected by sensors 1204 may be transmitted to mission control computing system 1203 via any of external interfaces 1224.

Autonomous vehicle 1202 may further include an autonomy computing system 1230. Autonomy computing system 1230 may control driving of autonomous vehicle 1202 through vehicle interface 1222. Autonomy computing system 1230 may operate autonomous vehicle 1202 to drive autonomous vehicle 1202 from one location to another.

In some embodiments, autonomy computing system 1230 may include modules for performing various functions. In this embodiment, autonomy computing system 1230 includes a calibration module 1232, a mapping module 1234, a motion estimation module 1236, a perception and understanding module 1238, a behaviors and planning module 1240, and a control module 1242. The modules and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 1202.

In some embodiments, based on the data collected from sensors 1204, autonomy computing system 1230 and, more specifically, perception and understanding module 1238 senses the environment surrounding autonomous vehicle 1202 by gathering and interpreting sensor data. Perception and understanding module 1238 interprets the sensed environment by identifying and classifying objects or groups of objects in the environment. For example, perception and understanding module 1238 in combination with various sensors 1204 (e.g., LIDAR sensors 1208, cameras 1210, RADAR sensors 1206, etc.) of autonomous vehicle 1202 may identify one or more objects (e.g., pedestrians, vehicles, debris, etc.) and features of a roadway (e.g., lane lines) around autonomous vehicle 1202, and classify the objects in the road distinctly.

In some embodiments, a method of controlling an autonomous vehicle, such as autonomous vehicle 1202, includes collecting perception data representing a perceived environment of autonomous vehicle 1202 using perception and understanding module 1238, comparing the perception data collected with digital map data, and modifying operation of autonomous vehicle 1202 based on an amount of difference between the perception data and the digital map data. Perception data may include sensor data from sensors 1204, such as cameras 1210, LIDAR sensors 1208, RADAR sensors 1206, or from other components such as motion estimation module 1236 and mapping module 1234.

Mapping module 1234 receives perception data or raw sensor data that can be compared to one or more digital maps stored in mapping module 1234 to determine where autonomous vehicle 1202 is in the world or where autonomous vehicle 1202 is on the digital map(s). In particular, mapping module 1234 may receive perception data from perception and understanding module 1238 or from the various sensors sensing the environment surrounding autonomous vehicle 1202 and may correlate features of the sensed environment with details (e.g., digital representations of the features of the sensed environment) on the one or more digital maps. The digital map may have various levels of detail and can be, for example, a raster map, or a vector map. The digital maps may be stored locally on autonomous vehicle 1202 or stored and accessed remotely. In at least one embodiment, autonomous vehicle 1202 deploys with sufficient stored information in one or more digital map files to complete a mission without connection to an external network during the mission.

Behaviors and planning module 1240 and control module 1242 plan and implement one or more behavior-based trajectories to operate autonomous vehicle 1202 similarly to a human driver-based operation. Behaviors and planning module 1240 and control module 1242 use inputs from perception and understanding module 1238 or mapping module 1234 and motion estimation module 1236 to generate trajectories or other planned behaviors. For example, behavior and planning module 1240 may generate potential trajectories (e.g., reference path 302 depicted in FIG. 3) or actions and select one or more of the trajectories to follow or enact by control module 1242 as the vehicle travels along the road. The trajectories may be generated based on proper (i.e., legal, customary, and safe) interaction with other static and dynamic objects in the environment. Behaviors and planning module 1240 may generate local objectives (e.g., following rules or restrictions) such as, for example, lane changes, stopping at stop signs, etc. Additionally, behaviors and planning module 1240 may be communicatively coupled to, include, or otherwise interact with motion planners, such as motion planning system 116 and/or the tactical planner previously described, which may generate paths or actions to achieve local objectives. Local objectives may include, for example, reaching a goal location while avoiding obstacle collisions.

Based on the data collected from sensors 1204, autonomy computing system 1230 performs calibration, analysis, and planning, and controls the operation and performance of autonomous vehicle 1202. For example, autonomy computing system 1230 estimates the motion of autonomous vehicle 1202, calibrates parameters of sensors 1204, such as the extrinsic rotations of cameras 1210, LIDAR sensors 1208, RADAR sensors 1206, and IMU 1218, as well as intrinsic parameters, such as lens distortions, in real-time, and provide a map of surroundings of autonomous vehicle 1202 or the travel routes of autonomous vehicle 1202. Autonomy computing system 1230 analyzes the behaviors of autonomous vehicle 1202 and generates and adjusts the trajectory plans for autonomous vehicle 1202 based on the behaviors computed by behaviors and planning module 1240.

In some embodiments, mission control computing system 1203 may transmit control commands or data to the autonomous vehicle 1202, navigation commands, and travel trajectories to the autonomous vehicle 1202, and may receive telematics data from the autonomous vehicle 1202 via external interfaces 1224.

In some embodiments, autonomy computing system 1230 interacts with motion planning system 116, and provides reference path 302 to motion planning system 116 in order for motion planning system 116 to generate spatiotemporal safety corridors 602, 902 for autonomous vehicle 1202. Thus, autonomous vehicle 1202 may operate similar to vehicle 100 as previously described.

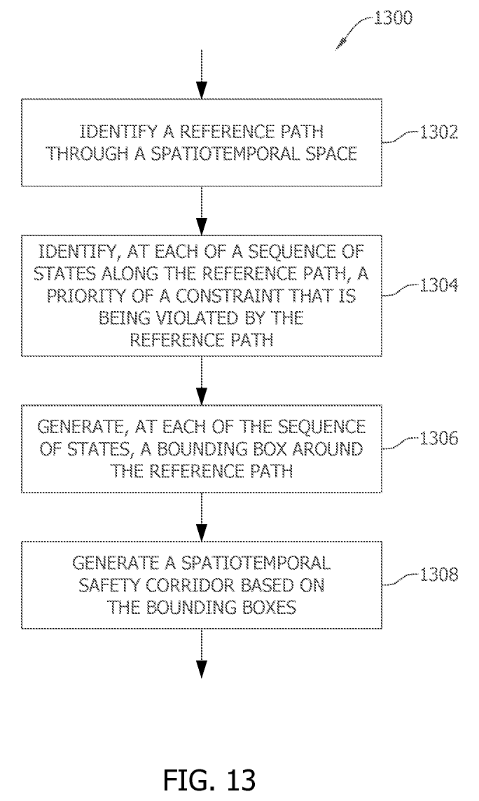

FIG. 13 depicts a flow chart of a method 1300 of planning motion for a vehicle in an exemplary embodiment. Method 1300 will be discussed with respect to motion planning system 116 of FIGS. 2 and 12, although method 1300 may be performed by other systems, not shown.

At 1302 of method 1300, a reference path through a spatiotemporal space is identified. The spatiotemporal space includes at least two spatial dimensions and a time dimension. The at least two spatial dimensions define a spatial frame, and the reference path is defined as a sequence of states of the vehicle along the reference path. For example, processor 202 of motion planning system 116 identifies reference path 302 through spatiotemporal space 300 that includes lateral dimension 304, longitudinal dimension 306, and time dimension 308 (see FIG. 3). In some embodiments, reference path 302 is provided to motion planning system 116 by another system, such as autonomy computing system 1230 of autonomous vehicle 1202 (see FIG. 12). In other embodiments, reference path 302 is generated by processor 202 of motion planning system 116.

At 1304 of method 1300, a priority of a constraint that is being violated by the reference path is identified at each of a sequence of states along the reference path. The constraints have different priorities. The constraints may represent rules of the road and/or be based on the capability of the vehicle to vary one or more of its velocity and direction. For example, processor 202 of motion planning system 116 identifies, at each of states 310, 312, 314, 316, 318 along reference path 302, a priority of one of constraints 206 that is being violated by reference path 302. Constraints 206 may represent rules of the road and/or be based on the capability of vehicle 100 to vary one or more of its velocity and direction.

At 1306 of method 1300, a bounding box is generated at each of the sequence of states along the reference path. The bounding box has an area in the spatial frame that does not violate the remaining constraints that have priorities higher than the priority of the constraint that is being violated by the reference path. For example, processor 202 of motion planning system 116 generates bounding boxes 502, 504, 506, 508, 510, at each of states 310, 312, 314, 316, 318, respectively (see FIG. 5). Bounding boxes 502, 504, 506, 508, 510 each have an area in the spatial frame (defined by lateral dimension 304 and longitudinal dimension 306) that does not violate remaining constraints 206 having priorities higher than the priority of the constraint that is being violated at states 310, 312, 314, 316, 318 (see, e.g., FIG. 4 regarding inflating bounding boxes 502, 504, 506, 508, 510 with respect to the priorities of constraints 206).

At 1308 of method 1300, a spatiotemporal safety corridor is generated for the vehicle through the spatiotemporal space based on the bounding boxes at each of the sequence of states. For example, processor 202 of motion planning system 116 generates spatiotemporal safety corridors 602, 902 through spatiotemporal space 300 based on bounding boxes 502, 504, 506, 508, 510 along reference path 302.

In some embodiments of method 1300, the constraints represent obstacles in the spatial frame and safety regions around the obstacles. For example, one or more of constraints 206 represent obstacles in the spatial frame (defined by lateral dimension 304 and longitudinal dimension 306) and safety regions around the obstacles.

In some embodiments of method 1300, the safety regions vary based on a predicted velocity of the vehicle at the sequence of states. For example, the safety regions of constraints 206 vary (e.g., increase in size or area or decrease in size or area) based on a predicted velocity of vehicle 100 at states 310, 312, 314, 316, 318.

In some embodiments of method 1300, a highest priority constraint is identified that is being violated. For example, multiple constraints 206 may be violated at states 310, 312, 314, 316, 318, and the highest priority constraint 206 is identified and used when inflating bounding boxes 502, 504, 506, 508, 510.

In some embodiments of method 1300, the bounding boxes have an area that is not greater than (i) the area in the spatial frame that does not violate higher priority constraints or (ii) a pre-defined area. For example, bounding box 502 may have an area that is not greater than the area in the spatial frame (defined by lateral dimension 304 and longitudinal dimension 306) that does not violate higher priority constraints 206, or a pre-defined maximum area. The pre-defined maximum area may be based on a multiple of a width of a lane of a road and/or a multiple of a length of the vehicle (e.g., vehicle 100).

An example technical effect of the embodiments described herein includes at least improving driving outcomes by providing spatiotemporal safety corridors around an initial route, where the spatiotemporal safety corridors ensure that a route defined therein does not violate higher priority constraints that were not violated by the initial route.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A motion planning system for planning motion for a vehicle, the motion planning system comprising:
a memory configured to store a plurality of constraints having different priorities;
at least one processor configured to:
identify a reference path through a spatiotemporal space that includes at least two spatial dimensions and a time dimension, wherein the at least two spatial dimensions define a spatial frame, and wherein the reference path is defined as a sequence of states of the vehicle along the reference path;
identify, at each of the sequence of states along the reference path, a priority of a constraint of the plurality of constraints that is being violated by the reference path;
generate, at each of the sequence of states along the reference path, a bounding box around the reference path having an area in the spatial frame that does not violate remaining constraints of the plurality of constraints having priorities higher than the priority of the constraint that is being violated by the reference path; and
generate, based on the bounding box at each of the sequence of states along the reference path, a spatiotemporal safety corridor for the vehicle through the spatiotemporal space.

2. The motion planning system of claim 1, wherein:
at least one of the plurality of constraints represents obstacles in the spatial frame and safety regions around the obstacles.

3. The motion planning system of claim 2, wherein:
the safety regions vary based on a predicted velocity of the vehicle at the sequence of states.

4. The motion planning system of claim 1, wherein the at least one processor, to identify the priority of the constraint that is being violated by the reference path, is further configured to:
identify, at each of the sequence of states along the reference path, a highest priority constraint of the plurality of constraints that is being violated by the reference path.

5. The motion planning system of claim 1, wherein the at least one processor, to generate the bounding box, is further configured to:
generate the bounding box to have the area that is not greater than (i) the area in the spatial frame that does not violate the remaining constraints of the plurality of constraints having the priorities higher than the constraint that is being violated by the reference path, or (ii) a pre-determined maximum area.

6. The motion planning system of claim 5, wherein:
the pre-determined maximum area is based on a multiple of a width of a lane of a road.

7. The motion planning system of claim 5, wherein:
the pre-determined maximum area is based on a multiple of a length of the vehicle.

8. The motion planning system of claim 1, wherein:
at least one of the plurality of constraints represents rules of a road.

9. The motion planning system of claim 1, wherein:
at least one of the plurality of constraints is based on a capability of the vehicle to vary at least one of a velocity and a direction of the vehicle within the spatial frame.

10. A method of planning motion for a vehicle, the method comprising:
identifying a reference path through a spatiotemporal space that includes at least two spatial dimensions and a time dimension, wherein the at least two spatial dimensions define a spatial frame, and wherein the reference path is defined as a sequence of states of the vehicle along the reference path;
identifying, at each of the sequence of states along the reference path, a priority of a constraint of a plurality of constraints that is being violated by the reference path, wherein the plurality of constraints have different priorities;
generating, at each of the sequence of states along the reference path, a bounding box around the reference path having an area in the spatial frame that does not violate remaining constraints of the plurality of constraints having priorities higher than the priority of the constraint that is being violated by the reference path; and
generating, based on the bounding box at each of the sequence of states along the reference path, a spatiotemporal safety corridor for the vehicle through the spatiotemporal space.

11. The method of claim 10, wherein:
at least one of the plurality of constraints represents obstacles in the spatial frame and safety regions around the obstacles.

12. The method of claim 11, wherein:
the safety regions vary based on a predicted velocity of the vehicle at the sequence of states.

13. The method of claim 10, wherein identifying the priority of the constraint that is being violated by the reference path further comprises:
identifying, at each of the sequence of states along the reference path, a highest priority constraint of the plurality of constraints that is being violated by the reference path.

14. The method of claim 10, wherein generating the bounding box further comprises:
generating the bounding box to have the area that is not greater than (i) the area in the spatial frame that does not violate the remaining constraints of the plurality of constraints having the priorities higher than the constraint that is being violated by the reference path, or (ii) a pre-determined maximum area.

15. The method of claim 14, wherein:
the pre-determined maximum area is based on a multiple of a width of a lane of a road.

16. The method of claim 14, wherein:
the pre-determined maximum area is based on a multiple of a length of the vehicle.

17. The method of claim 10, wherein:
at least one of the plurality of constraints represents rules of a road.

18. The method of claim 10, wherein:
at least one of the plurality of constraints is based on a capability of the vehicle to vary at least one of a velocity and a direction of the vehicle within the spatial frame.

19. A motion planning system for planning motion for a vehicle, the motion planning system comprising:
a memory configured to store a first constraint having a first priority and a second constraint having a second priority, wherein the first priority has a higher priority than the second priority, and wherein the first constraint and the second constraint represent at least one of (i) obstacles in a spatial frame and safety regions around the obstacles, and (ii) rules of a road; and
at least one processor configured to:
identify a reference path through a spatiotemporal space that includes at least two spatial dimensions and a time dimension, wherein the at least two spatial dimensions define the spatial frame, and wherein the reference path is defined as a sequence of states of the vehicle along the reference path;
determine, at one of the sequence of states along the reference path, that the second constraint having the second priority is being violated by the reference path;
generate, at the one of the sequence of states along the reference path, a bounding box around the reference path having an area in the spatial frame that does not violate the first constraint having the first priority; and
generate, based on the bounding box at the one of the sequence of states along the reference path, a spatiotemporal safety corridor for the vehicle through the spatiotemporal space.

20. The motion planning system of claim 19, wherein the at least one processor, to generate the bounding box, is further configured to:
generate the bounding box to have the area that is not greater than (i) the area in the spatial frame that does not violate the first constraint, or (ii) a pre-determined maximum area, wherein the pre-determined maximum area is based on one or more of:
a multiple of a width of a lane of the road; and
a multiple of a length of the vehicle.
